(19) United States
(12) Patent Application Publication
(10) Pub. No.: US 2002/0031104 A1
(43) Pub. Date: Mar. 14, 2002

(54) Methods and systems for interfacing wired/wireless hybrid systems

(75) Inventors: Thomas Griffith, Fairfax, VA (US); Stefen Van Rafelghem, Centerville, VA (US); Stephen Russell, Fairfax, VA (US); Ronald Hirsch, Fairfax, VA (US)

Correspondence Address: Oliff & Berridge PLC, P.O. Box 19928, Alexandria, VA, 22320, US

(73) Assignee: AVTEC SYSTEMS, INC., Fairfax, VA

(21) Appl. No.: 09/883,347

(22) Filed: Jun. 19, 2001

Related U.S. Application Data
(60) Provisional application No. 60/231,412, filed on Sep. 8, 2000.

(51) Int. Cl. H04Q 7/00

(52) U.S. Cl. 370/329; 370/352

(57) ABSTRACT

Methods and systems are provided to manage communications in networks having wired and wireless portions. By determining the optimum segment size for a wireless link based on various status conditions such as bit-error rates, data throughput across the wireless link can be improved. Accordingly, data received from a wired network can be repackaged using the desired segment size before being transmitted over the wireless link. Similarly, optimum-sized segments can be received from the wireless link and the data in the received segments can be passed to the wired network.

This non-provisional application claims the benefit of U.S. Provisional Application No. 60/231,412 entitled “SECURITY MECHANISMS TO AVERT THREATS IN WIRELESS NETWORK OPERATIONS” filed on Sep. 8, 2000 (Attorney Docket No. 105603). The applicants of the provisional application are Ronald HIRSCH, Stefen Van RAFELGHEM, Thomas GRIFFITH and Stephen RUSSELL. The above provisional application is hereby incorporated by reference in its entirety including all references cited therein.

### BACKGROUND OF THE INVENTION

1. Field of Invention

This invention relates to methods and systems for managing communications in networks having wired and wireless portions.

2. Description of Related Art

As global telecommunications networks expand, the need to efficiently interface wired networked systems, such as the Internet, to wireless systems increases commensurately. Unfortunately, most existing wired and wireless systems were developed having different design criteria in mind. As a result, current wired and wireless systems are at best marginally compatible. While various wired/wireless interfaces are currently available to remedy the incompatibility between wired and wireless systems, these interfaces generally must incorporate a large number of compromises. As a result, the wired/wireless interfaces can inadvertently cause excessive delays while transferring data from a wired system to a wireless system. Accordingly, new apparatus and methods that can more efficiently interface wired and wireless systems are needed.

### SUMMARY OF THE INVENTION

The present invention provides methods and systems for optimizing the data transmission rates across wired/wireless interfaces using dynamic segment sizing over the wireless portions of the network. In various embodiments, a technique is described for transferring data over a wireless link. In operation, one or more wireless transmission control protocol (TCP) segments are received from the wireless link. The data in the first TCP segment is then extracted and provided to an external device, such as a wired network or mobile wireless device. To improve data throughput, the size of wireless segments can be determined based on a status condition associated with the wireless link, such as bit errors, framing errors, signal strength, signal-to-noise ratios and the like.

Other features and advantages of the present invention are described below and are apparent from the accompanying drawings and from the detailed description which follows.

### BRIEF DESCRIPTION OF THE DRAWINGS

The invention is described in detail with regard to the following Figures, wherein like numerals reference like elements, and wherein:

FIG. 1 is a block diagram of an exemplary wired/wireless data network;

FIG. 2 is a block diagram of a first exemplary wireless link according to the present invention;

FIG. 3 is a block diagram of a second exemplary wireless link according to the present invention;

FIG. 4 depicts an exemplary timing diagram of a data transfer and acknowledgment across an error-free wireless link;

FIG. 5 depicts an exemplary timing diagram of a data transfer and acknowledgment across an error-prone wireless link;

FIG. 6 depicts an exemplary timing diagram of a data transfer and acknowledgment across an error-prone wireless link using a modified packet format;

FIG. 7 is a block diagram of the wireless device of FIG. 1;

FIG. 8 is a block diagram of the data interface of FIG. 7;

FIGS. 9 is a flowchart outlining an exemplary technique for managing communications in a wired/wireless hybrid system; and

FIGS. 10 is a flowchart outlining another exemplary technique for managing communications in a wired/wireless hybrid system.

### DETAILED DESCRIPTION OF PREFERRED EMBODIMENTS

Generally, data networks such as the Internet are controlled by multiple network protocols, which are commonly classified into various layers including a physical layer, a data link layer and a network layer. Because physical systems are imperfect, noise and distortion, such as cross-talk, impulse noise, bit-errors and inter-symbol interference (ISI), in a network's physical layer can corrupt data as it traverses the network. As a result, a segment of data traversing a network can be inundated with errors by the time it reaches an intended receiver.

Transmission control protocol (TCP) is a predominant network layer protocol that is used for managing data transfer. TCP transmits data across a network by packaging the data into segments of various predetermined sizes and transporting the data segments using the physical portion of the network. Generally, when the physical portion of network is a wired network, such as a T1, E1 or 10baseT system, the number of errors introduced into a data segment are relatively small.

In contrast, when a network is a wireless network, such as a cellular or satellite-based communication system, the number of errors introduced into a data segment can be orders of magnitude greater than that of a wired network. As a result, a large data segment suitable for transmission across a wired network may not likely traverse a wireless link without being corrupted. In operation, such large segments may need to be retransmitted numerous times before being successfully delivered to an intended wireless receiver, which can cause excessive delays, and thus, form debilitating bottlenecks across the wireless link.

Furthermore, if a TCP segment takes too long to reach its intended destination, a TCP “time-out” condition can occur. As a result of the TCP time-out, the data contained in the failed segment must not only be retransmitted, but the TCP “window” of a receiving device can be drastically reduced in size. This TCP window-size reduction, in turn, can slow the overall data throughput rate and thus, another bottleneck can arise as data is unnecessarily forced to “trickle” across the wired portions of the network.

However, by buffering a TCP segment received from a wired network using an intermediate controller, optionally providing an acknowledgment signal from the controller, and then determining the optimum segment size for data traversing a particular outgoing wireless link, the received TCP segment can be reformatted into a number of smaller, or otherwise more appropriately sized, segments designed to optimize data throughput across the wireless network.

Additionally, by determining an optimum TCP segment size for data received from a wireless device, as opposed to data transmitted to the wireless device, data throughput rates can be similarly optimized without regard to limitations and demands of the wired network. That is, by receiving optimally-sized wireless segments, extracting and buffering the data in the received segments and then passing the extracted data to the wired network in segments having a size appropriate for the wired network, data throughput can be optimized.

Accordingly, any deleterious effects, such as noise and distortion, found in a wireless portion of a data pathway can be minimized or effectively isolated from a wired portion of the data pathway. As a result, the data transfer rate across wired/wireless hybrid networks can be improved as the possibility of excessive numbers of retransmissions and TCP time-outs are reduced.

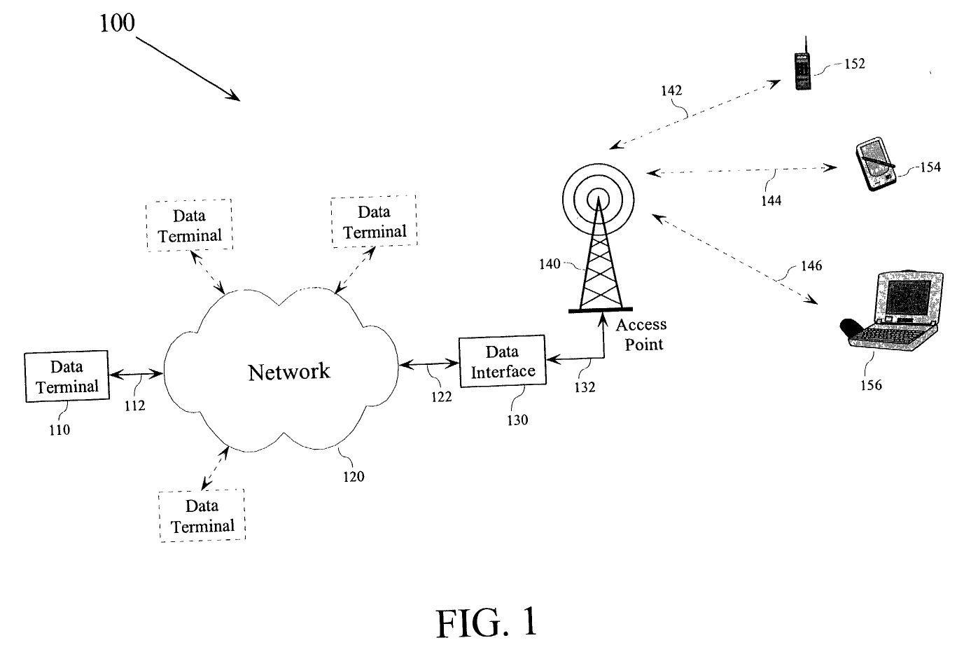

FIG. 1 is a block diagram of an exemplary transmission system 100 having both wired and wireless portions. The transmission system 100 includes a data interface 130 coupled to a data terminal 110 through a network 120, and further connected to an access point 140. The access point 140, in turn, is coupled to a number of wireless devices, such as a cellular phone 152, personal digital assistant (PDA) 154 and a portable computer 156, for example.

In operation, the data terminal 110 can transmit data to and receive data from the network 120 over link 112, which in turn can transmit data to and receive data from the data interface 130 over link 122. The exemplary data terminal 110 can be a personal computer executing Transmission Control Protocol (TCP) operating over Internet Protocol (IP), commonly referred to as TCP/IP. However, the data terminal 110 can also be any one of a number of different types of data sources, such as a computer, a storage device, or any combination of software or hardware capable of generating, relaying, or recalling from storage data capable of being transmitted, directly or indirectly, to a transmission network, or medium, using a network protocol without departing from the spirit and scope of the present invention.

The exemplary network 120 can be a portion of the Internet. However, the network 120 can also be a wide area network or a local area network, an intranet, any subset of the Internet, or any distributed processing network or system. In general, the transmission network 120 can be any known or later developed combination of transmission mediums, computer programs, or structures usable to transmit data between the data source 110 to the data interface 130 without departing from the spirit and scope of the present invention.

Accordingly, the first and second data links 112 and 122 of the exemplary embodiment can be links with the Internet. However, the first and second data links 112 and 122 can also be links on a wide area network or a local area network, an intranet, any subset of the Internet, or links on any distributed processing network or system. In general, the first and second data links 112 and 122 can be any known or later developed transmission medium, computer program, or structure usable to transmit data between the network 120 and the data terminal 110 and data interface 130, respectively, without departing from the spirit and scope of the present invention.

While the exemplary data terminal 110, network 120 and data interface 130 can communicate using TCP, the various devices 110-130 can, in other exemplary embodiments, communicate using other existing communication protocols. Furthermore, because protocols can evolve over time or be replaced in part or in whole, it should be appreciated that the various devices 110-130 can communicate using any known or later developed protocol such as Ethernet or 10baseT or UDP, or variants thereof without departing from the spirit and scope of the present invention. Accordingly, in various embodiments, the term “segment” can include any form of packaged information containing a finite amount of data according to any known or later developed protocol useful for transporting information.

Returning to FIG. 1, as TCP segments are transmitted from the data terminal 110 to the various wireless devices 152-156, the data interface 130, being an intermediate device, can receive the TCP segments and verify that the data in each TCP segment is not corrupted, i.e., contains no non-correctable errors. If the data in a TCP segment is corrupted, the data interface 130 can send an acknowledgment signal to the data terminal 110 indicating that the particular TCP segment was unsuccessfully received and, according to TCP protocol, the data terminal 110 can repeatedly retransmit the TCP segment until the segment is successfully received.

Otherwise, if a particular TCP segment is successfully received, the data interface 130 can buffer the data in the TCP segment and, in various exemplary embodiments, send a signal to the data terminal 110 acknowledging that the TCP segment was successfully received by the data interface 130. While the exemplary data interface 130 can send an acknowledgment signal to the source of a particular segment immediately after reception, it should be appreciated that, in various embodiments, the data interface 130 can first deliver the data in a received segment to an intended destination, such as one of the wireless devices 152-156, confirm successful delivery to the wireless device 152, 154 or 156 and then return an acknowledgment signal to the data terminal 110.

As the data interface 130 communicates with the data terminal 110, the data interface 130 can simultaneously communicate with the access point 140 and the wireless devices 152-156. That is, the data interface 130 can transmit data to and receive data from the access point 140 via link 132. Furthermore, the access point 140 can relay information to and from the wireless devices 152-156 via wireless links 142-146 respectively.

The third data link 132, like the first and second data links 112 and 122, can be any known or later developed device or system for connecting the data interface 130 to the access point 140. Such devices include direct serial/parallel cable connections, wireless connections, satellite links, connections over a wide area network or a local area network, connections over an intranet, connections over the Internet, or connections over any other distributed processing network or system. Additionally, the third data link 132 can be software devices linking various software systems. In general, the third data link 132 can be any known or later developed connection system, computer program, or structure usable to transport data between the data interface 130 and the access point 140.

The exemplary access point 140 is a wireless transmitter/receiver capable of transmitting and receiving various radio signals according to a CDMA-based protocol. However, the access point 140 alternatively can be any one of a number of different devices, such as a radio-frequency (RF) or microwave wireless transmitter/receiver, a transmission/reception system employing wires such as a twisted wire pair, a transmitter/receiver adapted for transmitting across coaxial cable, an optical transmitter/receiver, a fiber-optic transmitter/receiver, a sonic transmitter/receiver or any other known or later developed device suitable for transmitting/receiving data. Accordingly, the wireless devices 152-156 can be any number of devices capable of communicating with the access point 140 including specially adapted computer-based systems, cellular phones, PDAs and the like.

In addition to sending and receiving data to/from the wireless devices 152-156, the data interface 130 can receive status information generated by the access point 140 and/or generated by the various wireless devices 152-156. Additionally, the data interface 130 can extract or otherwise derive other status information from segments received from the wireless devices 152-156.

For example, in various embodiments, the access point 140 and the wireless devices 152-156, alone or in combination, can measure various status conditions associated with their respective links 142-146 as they receive communication signals from the access point 140. For instance, a wireless device can measure various parameters associated with the physical-layer of its wireless link with a particular access point, such as the strength of a radio signal received by the wireless device, a signal-to-noise ratio (SNR), a signal-to-interference ratio (SI), a signal-to-interference-plus-noise ratio (SINR), the impulse response/transfer function of the wireless link or any other parameter conceptually associated with a wireless signal, such as a CDMA, TDMA or like radio signal without departing from the spirit and scope of the present invention.

In other exemplary embodiments, a wireless device can measure various status conditions associated with the data-link layer of a wireless link with a particular access point including bit-error rates (BER), octet/byte errors, frame or multi-frame errors, synchronization errors, loss of signal or any other parameter conceptually associated with a data-link layer without departing from the spirit and scope of the present invention.

In still other exemplary embodiments, a wireless device can measure various status conditions associated with the network layer of a wireless link such as a number of erroneous, i.e., corrupted, segments, time-out errors, echo request errors, unknown or erroneous message errors, “ping” errors or any other parameter conceptually associated with a network layer without departing from the spirit and scope of the present invention.

As a particular wireless device 152, 154 or 156 performs its various status/error measurements, the particular wireless device 152, 154 or 156 can report any number of determinable status conditions or derivative information to the data interface 130 through the access point 140.

The access point 140, in addition to relaying status condition information derived by the wireless devices 152-156, can similarly perform similar status condition measurements for signals received from the wireless devices 152-156. Once the access point 140 has measured the various status conditions for a particular wireless link 142, 144 or 146, the access point 140 can report this status condition information both to the data interface 130 and to the respective wireless device 152, 154 or 156.

Once the data interface 130 has received the appropriate status condition information for a particular wireless link 142, 144 or 146, the data interface 130 can determine a number of operational parameters designed to optimize or otherwise improve data throughput based on the status information. That is, as the data interface 130 receives a TCP segment from the data terminal 110, the data interface 130 can repackage the data in the received TCP segment, based in part or in whole on the status information, into a form more suitable for transmission across the wireless link 142, 144 or 146.

For example, if status information associated with a particular wireless link 142, 144 or 146 indicates that the wireless link 142, 144 or 146 is likely to introduce relatively few errors into a communication signal traversing a wireless link 142, 144 or 146, the data interface 130 can pass TCP segments received from the network 120 to a respective wireless device 152, 154 or 156 without modification. If the TCP segments received from the network 120 are small, the data interface 130 can even aggregate the data in the received segments and pass larger-sized segments to the respective wireless device 152, 154 or 156.

In contrast, however, if status information associated with a particular wireless link 142, 144 or 146 indicates that the wireless link 142, 144 or 146 is likely to introduce errors, or if the status information indicates a trend that a particular wireless link 142, 144 or 146 is becoming increasingly susceptible to errors, it should be appreciated that the data interface 130 can repackage the data received from the network 120 in smaller-sized segments and have the smaller-sized segments transmitted over the wireless link 142, 144 or 146.

While the data interface 130 can receive and forward data to the wireless devices 152-156, it should be appreciated that the wireless devices 152-156 can receive/generate data and similarly provide the data to the data interface 130. That is, the wireless devices 152-156 can receive status condition information from the data interface 130 and the access point 140. The wireless devices 152-156 can then determine an optimum or otherwise advantageous segment size for each of their respective wireless links 142-146 to the access point 140 and transmit data using their respective optimum packet sizes.

It should further be appreciated that, in various embodiments, the wireless devices 152-156 can be modified to directly communicate with one another. For example, wireless device 152 can communicate with wireless device 154 using a direct wireless link (not shown). As the wireless devices 152 and 154 communicate, the wireless devices 152 and 154 can measure various status conditions relating to the direct wireless link and provide the measured status condition information to one another. Accordingly, each of the wireless devices 152 and 154 can determine the optimum segment size that will substantially optimize the data throughput rate. For instance, based on status condition information measured and provided by wireless device 152, wireless device 154 can determine the segment size appropriate for data transfers from wireless device 154 to wireless device 152. Similarly, based on status condition information measured and provided by wireless device 154, wireless device 152 can determine the segment size appropriate for data transfers from wireless device 152 to wireless device 154.

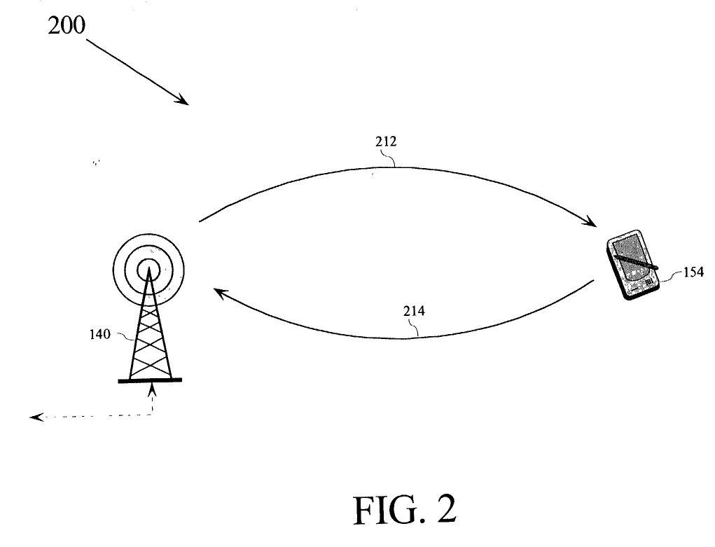

FIG. 2 is an exemplary cellular wireless link 200 between an access point 140 and a PDA 154 having a wireless transmitting/receiving device. As shown in FIG. 2, the wireless link 200 has an outgoing channel 212 and an incoming channel 214. In operation, the outgoing channel 212 can carry various forms of information to the PDA 154, such as data derived from a network (not shown) and status information measured by the access point 140. Similarly, the incoming channel 214 can carry various forms of information to the access point 140, such as data derived from a network (not shown) and status information measured or otherwise determined by the PDA 154.

The exemplary channels 212 and 214 are radio-frequency CDMA continuous signals modulated according to a quadrature amplitude modulation (QAM) technique. However, it should be appreciated that, in various exemplary embodiments, the channels 212 and 214 can alternatively take various other known or later developed forms, such as time division multiple access (TDMA) channels, and can be modulated according to any other known or later developed technique, such as a frequency modulation (FM) technique, without departing from the spirit and scope of the present invention.

If an exemplary channel's physical layer is a continuous channel, then it should be appreciated that segments traversing the channel can be modified in size without affecting the characteristics of the physical layer of the channel 212 or 214. For example, a data interface can modify outgoing segments from 16,000 bits to 4,000 bits without causing the access point 140 to change the CDMA communication scheme or respective modulation technique. Similarly, if an exemplary channel's physical layer uses burst signals, such as an IS-136 channel, segments can be transported between the PDA 154 and access point 140 using burst signals having a constant size.

However, in various embodiments, if an exemplary channel's physical layer uses burst signals, then a segment size and burst signal size can be operationally merge. That is, the access point 140 and/or the PDA 154 can adjust the size of the burst signals traversing link 200 in response to changing status conditions, with each burst sized to carry a segment of data.

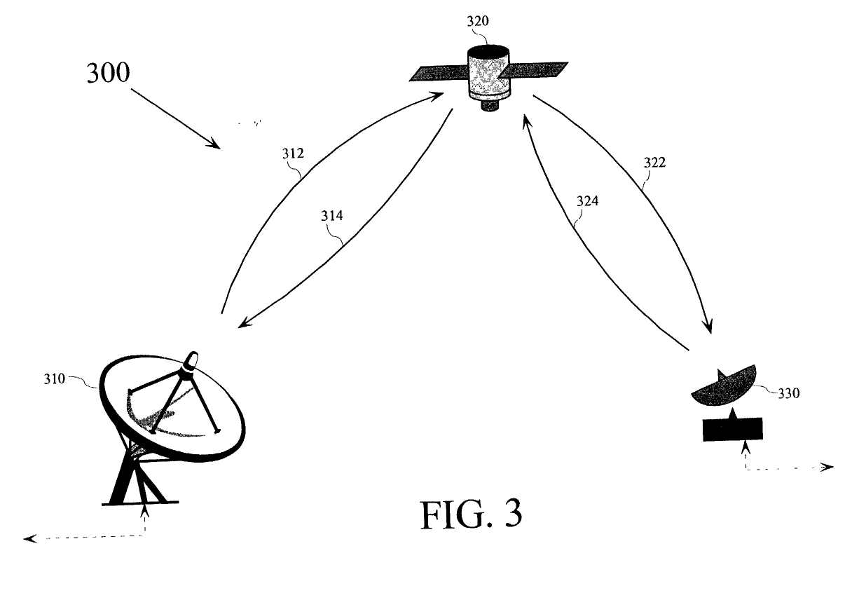

FIG. 3 is an exemplary satellite-based link 300 between an access point 310 and a remote wireless device 330 using one or more intermediate satellite(s) 320. As shown in FIG. 3, there is a first wireless link between the access point 310 and the satellite 320 consisting of a first outgoing channel 312 and a first incoming channel 314. Further, there is a second wireless link between the satellite 320 and the remote wireless device 330 consisting of a second outgoing channel 322 and a second incoming channel 324.

In operation, the access point 310 can transmit data, status and other information to the remote wireless device 330 via the first and second outgoing channels 312 and 322. Similarly, the remote wireless device 330 can transmit data, status and other information to the access point 310 via the second and first incoming channels 324 and 314.

As with FIG. 2, the access point 310 and remote wireless device 330 can measure various status conditions and manipulate segment size based on the measured status conditions. In various exemplary embodiments, the satellite 320 can act as a simple transceiver relaying signals. However, in various other embodiments, it should additionally be appreciated that the satellite 320 can measure various status conditions and manipulate segment size based on the measured status conditions.

For example, based on status conditions measured by the satellite 320 associated with channel 312 and relayed to the access point 310 using channel 314, a controller (not shown) can receive segments of 32,000 bits from a network, repackage the data into 4,000-bit segments and relay the 4,000-bit segments to the satellite via the access point 310. The satellite 320, in turn, can optionally repackage the 4,000-bit segments into 500-bit segments based on status conditions measured by the remote wireless device 330 associated with channel 322 and relayed using channel 324. Similarly, the satellite 320 can relay/repackage data from the remote wireless device 330 to the access point 310.

The exemplary satellite-based link 300 can be a TRDSS-based communication link. However, in various embodiments, it should be appreciated that the satellite-based link 300 can be based on any known or later developed satellite communication system such as INTELSAT, INMARSAT and the like without departing from the spirit and scope of the present invention.

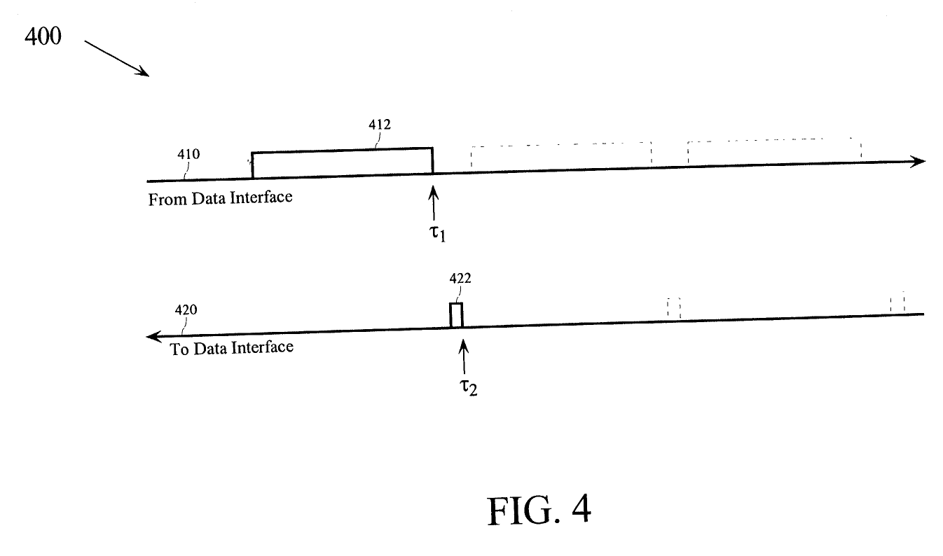

FIG. 4 depicts an exemplary timing diagram of an error-free wireless link 400. The wireless link 400 includes an outgoing channel 410 capable of carrying data segments and various other signals from a controller/access point to a wireless device, and an incoming channel 420 capable of data segments and various other signals from the wireless device back to the data interface/access point.

As shown in FIG. 4, the outgoing channel 410 can transport an outgoing segment 412. Because the outgoing channel 410 is error-free, the outgoing data segment 412 can be received by the wireless device without being corrupted, and therefore the outgoing data segment 412 can be successfully received by the wireless device by time τ₁.

After the outgoing data segment 412 is successfully received, the wireless device can send an incoming acknowledgment signal 422 signaling to the data interface that the outgoing data segment 412 was successfully received. Accordingly, an exchange of data with an appropriate acknowledgment can be completed by time τ₂.

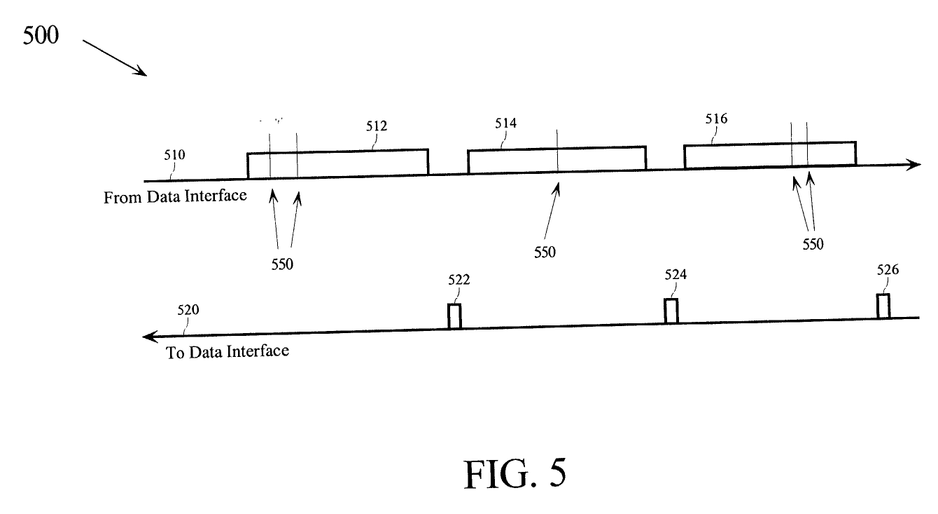

FIG. 5 depicts an exemplary timing diagram of an error-prone wireless link 500. The wireless link 500 includes an outgoing channel 510 capable of carrying data segments and various other signals from a data interface/access point to a wireless device, and an incoming channel 520 capable of carrying data segments and various other signals from the wireless device back to the data interface/access point.

Like the error-free link 400 of FIG. 4, the channels 510 and 520 of the error-prone link can contain data segments and other information, such as acknowledgment signals. However, unlike the error free link 400, the various outgoing data segment 512, 514 and 516 can be corrupted by a number of bit-errors 512.

In the exemplary timing diagram, the data interface/access point can send a first outgoing data packet 512. Because the first outgoing data segment 512 contains two bit-errors 550, the receiving wireless device will not successfully receive the first outgoing data segment 512 assuming that the first outgoing data segment 512 has an error detection capacity, but no error correction capacity, such as with TCP segments. Accordingly, the wireless device can return a first acknowledgment signal 522 indicating that the first outgoing data segment 512 was unsuccessfully received.

In response to the first failure acknowledgment signal 522, the data interface/access can retransmit the second outgoing data packet 514, which can be identical to the first outgoing data packet 512, in an attempt to complete the data transfer. Because the second outgoing data packet 514 is also corrupted, the wireless device can return a second acknowledgment signal 524 indicating that the second outgoing data segment 514 was unsuccessfully received.

In response to the second failure acknowledgment signal 524, yet another outgoing data packet 516 and acknowledgment signal 526 can be sent. The outgoing data can be repeatedly retransmitted until an outgoing data segment is successfully received and acknowledged by the wireless device. However, as discussed above, if a status condition such as a BER increases, it should be appreciated that the likelihood that segments of a particular size will successfully be transmitted can decrease until so many retransmissions are required that timely delivery of data is statistically unlikely.

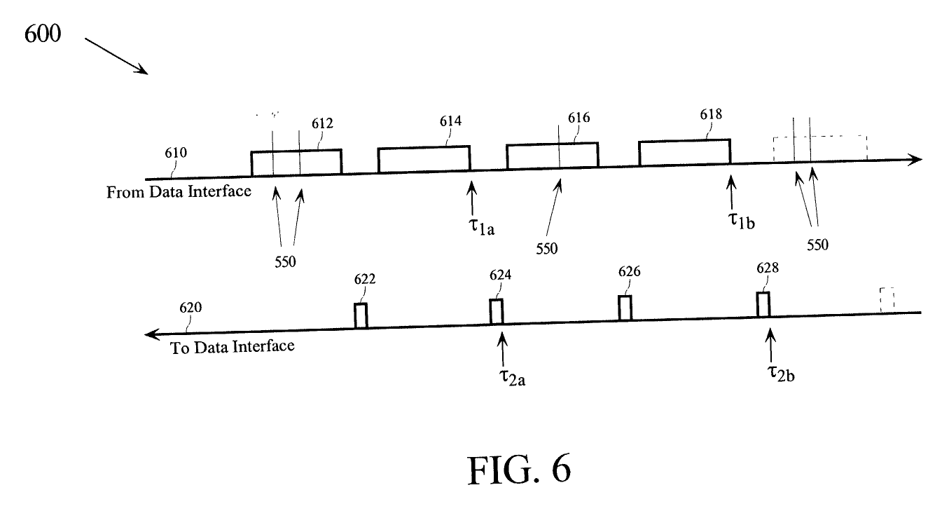

FIG. 6 depicts an exemplary timing diagram of a second error-prone wireless link 600. The second wireless link 600 includes an outgoing channel 610 capable of carrying data segments and various other signals from a data interface/access point to a wireless device, and an incoming channel 620 capable of carrying data segments and various other signals from the wireless device back to the data interface/access point.

Like the first error-prone link 500 of FIG. 5, the outgoing channel 610 of the second error-prone link 600 can contain data segments corrupted by errors. However, unlike the first error-prone link 500, the outgoing data segments 612-618 contain half the data of the outgoing data segments of FIG. 5. Accordingly, for equivalent data to be transferred, two smaller outgoing segments must be successfully received and acknowledged, as opposed to a single segment as with FIGS. 4 and 5.

In the exemplary timing diagram, the data interface/access point can send a first outgoing data packet 612. Because the first outgoing data segment 612 contains two bit-errors 550, the first outgoing data segment 612 will fail and the wireless device can return a first failure acknowledgment signal 622.

In response, the data interface/access point can retransmit the data of the first outgoing data segment using the second outgoing data segment 614. As shown in FIG. 6, because the second outgoing data segment 614 contains no errors, it can be successfully received by the wireless device by time τ₁ₐ and appropriately acknowledged with signal 624 by time τ_{1b}.

Next, the data interface/access point can transmit a second block of data using a third outgoing data segment 616. Because the third outgoing data segment 616 contains a bit-error 550, the wireless device can again return a respective failure acknowledgment signal 626. In response, the data interface/access point can retransmit the second block of data using the forth outgoing data segment 618 and, as shown in FIG. 6, because the forth outgoing data segment 618 contains no errors, it can be successfully received by the wireless device by time τ_{1b} and appropriately acknowledged with signal 628 by time τ_{2b}.

FIGS. 5-6 demonstrate that the rate of data transfer can be improved in noisy environments using multiple smaller data segments, as opposed to a single large data segment. Although parsing and transmitting data in smaller packets can potentially take longer than transmitting the equivalent amount of data in a single large packet, the smaller-sized segments can nonetheless increase the likelihood that data will be timely delivered and acknowledged in error-prone environments since the likelihood that each small segment will be successfully transmitted is greater.

For example, if a segment contains 32,000 bits and the BER of a respective communication channel is 1×10⁻⁴, then the probability that the 32,000-bit segment will be successfully received is (1−1×10⁻⁴)^{32,000}=0.9999^{32,000}=4.07%, assuming a binomial distribution. That is, each 32,000-bit segment will typically be retransmitted about twenty-five times on average and, thus 96% of the potential data capacity of the communication channel will likely be wasted.

However, if the same data stream used 4,000-bit segments, then the probability that each 4,000-bit segment will be successfully received is (1−1×10⁻⁴)^{4,000}=0.9999^{4,000}=67%. Accordingly, only 33% of the potential data capacity of the communication channel is wasted. Although some efficiency is lost due to the use of smaller segments, each requiring a separate acknowledgment signal, the overall increases the rate of data transfer is higher, and thus the potential for other error-conditions such as time-out errors is decreased.

While FIGS. 4-6 depict data transfers from a data interface to a wireless device, it should be appreciated that the efficiencies and advantages gained by adaptively changing segment sizes based on various status conditions as data is transported from the wired/wireless data interface to the wireless device can be similarly obtained as data is transported from the wireless device to the wired/wireless data interface as well as another wireless device.

For example, as a wireless device transmits data segments to an access point/data interface, the access point can measure various status conditions such as a BER, SNR and the like. The access point/data interface can then provide the status condition information to the wireless device using a complementary outgoing channel to the wireless device. Based on the status condition information, the wireless device can dynamically resize the data segments transmitted to the access point/data interface to improve the rate of data throughput over the incoming channel.

Although FIGS. 4-6 depict various data transfer efficiencies as a function of segment size, it should be appreciated that data transfer efficiencies can be improved in the presence of noise by affecting other aspects of a data stream's format. For instance, for a system undergoing an increasing BER, segments can be dynamically adapted to incorporate increasing levels of error correction, such as using progressively larger BCH blocks, to mitigate the number of corrupted segments at a receiver.

In still other embodiments, other format aspects such as convolutional codes, frame and superframe sizes and the bit-rate of a data stream can be dynamically adapted in response to a given status condition. Accordingly, it should be appreciated that any known or later developed aspect of a data stream's format associated with a network or data link layer of a wireless network capable of being adapted in response to various status conditions can be used without departing from the spirit and scope of the present invention.

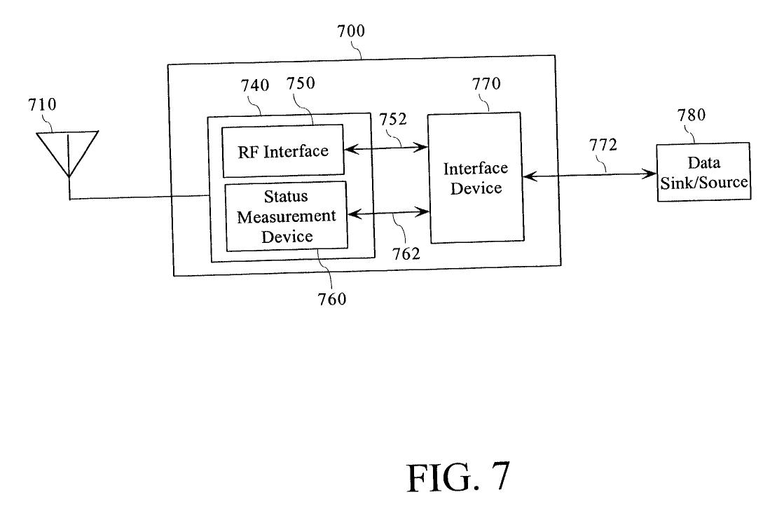

FIG. 7 is a block diagram of an exemplary wireless device 700 coupled to a data sink/source 780. The wireless device 700 includes an antenna 710, an interface device 770 and a front-end 740. The front-end 740 in turn contains an RF interface 750 and a status measurement device 760.

In operation, the wireless device 700 can receive various RF wireless signals containing segments of data and other information using the antenna 710. The wireless device 700 in turn can extract data from the received wireless signals and provide the extracted data to the data sink/source 780.

The exemplary data sink/source 780 can be any one of a number of different types of sink/source devices. Such devices can include a person interacting a cellular phone, a computer receiving/generating information, a storage device or any known or later-developed combination of software and hardware capable of receiving/generating, relaying, storing or recalling from storage, any information capable of being received/transmitted to the sink/source 780 without departing from the spirit and scope of the present invention.

As the antenna 710 receives the wireless signals, the antenna 710 can provide the wireless signals to the RF interface 750. The RF interface 750 can receive the wireless signals and perform various operations on the received wireless signals, such as frequency-shifting, demodulation, digital sampling, and equalization to produce a base-band representation of the received wireless signals. Once processed, the RF interface 750 can provide the base-band signals to the interface device 770 via link 752. As discussed above, wireless signals can contain various information, such as data segments, acknowledgment signals and other information. Accordingly, while the RF interface 750 can change the physical form of information received, it should be appreciated that the data segments and other information contained in the wireless signals can nonetheless remain unchanged.

As the RF interface 750 processes the received wireless signals, the status measurement device 760 can measure various status conditions associated with the received wireless signals. For example, the status measurement device 760 can measure the signal strength of the received wireless signal, the SNR, the SINR, the SI or any other known or later developed or recognized measurable quantity relating to a received wireless signal without departing from the spirit and scope of the present invention. As the status measurement device 760 measures or otherwise derives various status conditions, the status measurement device 760 can provide the status condition information to the interface device 770 via link 762.

The interface device 770 can receive the processed information and perform various operations on the processed information. For example, in a first series of operations, the interface device 770 can receive data segments from the RF interface 750, extract the data from the received data segments and provide the extracted data to the data sink/source 780 via link 772.

In another series of operations, the interface device 770 can receive status condition information from the status measurement device 760, and further measure or otherwise derive more status conditions using the signals received from the RF interface 750. For example, the interface device 770 can measure bit-errors, octet-errors, segment errors, framing errors or any other known or later developed or recognized status condition associated with a data-link or network layer without departing from the spirit and scope of the present invention.

As the interface device 770 accumulates or otherwise derives status conditions regarding a receive channel of the wireless device 700, the interface device 770 can calculate or otherwise estimate an optimum or otherwise advantageous segment size for segments traversing the receive channel. The exemplary interface device 770 can determine its preferred segment size using a variety of techniques. For example, in various embodiments, the interface device 770 can calculate a preferred segment size using a parametric model based on empirical data.

In other embodiments, the interface device 770 can calculate a preferred segment size using a look-up table derived from empirical data or theoretical models.

In still other embodiments, the interface device 770 can calculate a preferred segment size using an adaptive approach where segment sizes are incrementally changed as a function of the changing status conditions. However, the particular technique used to determine a preferred segment size can vary as desired and can include any known or later developed approach without departing from the spirit and scope of the present invention.

Once the interface device 770 has calculated the optimum or otherwise advantages segment size, the interface device 770 can transmit the calculated, or preferred, segment size and/or the accumulated status condition information to an access point (not shown) or similar device at the other end of the wireless link.

The access point can receive the preferred segment size or alternatively derive the preferred segment size using the received status conditions. Once received or derived, the access point can then transmit data to the wireless device 700 using the preferred segment size. As data is transmitted using the new, preferred segment size, the wireless device 700 can receive the modified segments and continue to measure the various status conditions. Accordingly, as status conditions continue to change, the wireless device 700 can update the preferred segment size as required.

Returning to FIG. 7, it should be appreciated that, besides receiving wireless signals from a wireless link and providing the data contained in the wireless signals to the data sink/source 780, the wireless device 700 can also receive data from the data sink/source 780, package the received data in segments and transmit the segments over the wireless link.

As the received data is packaged and transmitted by the wireless device 700, it should be appreciated that the preferred segment size for transmitted segments can be determined in a fashion similar to the segment sizes for received segments. For example, as the wireless device 700 transmits segments to an access point, the access point can measure or otherwise derive various status conditions associated with the wireless channel from the wireless device to the access point. The access point can then periodically provide the preferred segment size to the wireless device 700, wherein the wireless device 700 can incorporate the preferred segment sizes.

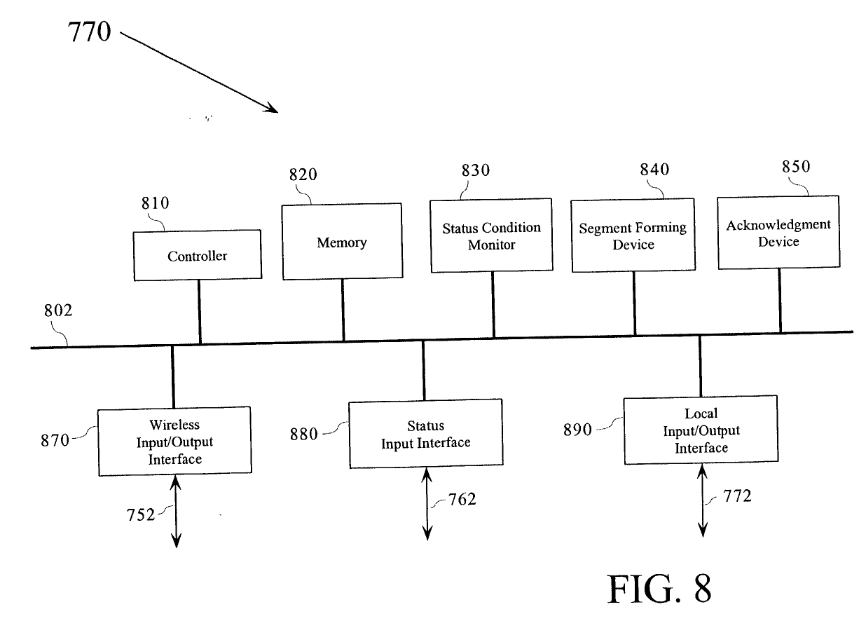

FIG. 8 is a block diagram of the interface device 770 of FIG. 7. The interface device 770 can include a controller 810, a memory 820, a status condition monitor 830, a segment forming device 840, an acknowledgment device 850, a wired network input/output interface 870, a status input interface 880 and a wireless network input/output interface 890. The above components are coupled together by control/data bus 802. Although the exemplary interface device 770 uses a bussed architecture, it should be appreciated that any other architecture may be used as is well known to those of ordinary skill in the art.

In a first series of operations, and under control of the controller 810, the wireless input/output interface 870 can receive signals, such as data segments and other information, from a wireless receive channel (not shown) using link 752, and provide the signals to the memory 820, the status condition monitor 830 and to the acknowledgment device 850.

For each received segment, the acknowledgment device 850 can determine whether the data in the segment is corrupted. If the data in a particular segment is corrupted, then the acknowledgment device 850 can purge the corrupted segment from the memory 820 and send an acknowledgment signal to the source of the segment indicating that the particular segment is corrupted using a wireless transmit channel and the wireless input/output interface 870.

However, if a segment is valid, then the acknowledgment device 850 can send an acknowledgment signal to the controller 810 and the source of the segment indicating that the particular segment is valid. The controller 810 can then extract the data from the received segments and provide the data to an external device, such as a data sink (not shown) via the local input/output interface 890 and link 772.

The status condition monitor 830 can receive the various signals and measure or otherwise derive various status conditions using the received signals. For example, as discussed above, the status condition monitor 830 can receive a number of segments and determine whether the segments contain various bit-errors, octet-errors, segment-errors and the like.

In addition to performing status condition measurements, the status condition monitor 830 can also import other status condition information using the status input interface 880 and link 762, such as a BER, an SNR, an SINR or any other known or later developed or recognized quantity relating to the performance of a wireless link without departing from the spirit and scope of the present invention.

Once the status condition monitor 830 has accumulated the various status conditions, the status condition monitor 830 can determine an optimum or otherwise advantageous segment size for segments received over the wireless receive channel. As discussed above, the preferred segment size can be determined using various approaches such as using parametric equations or look-up tabled based on theoretical or empirical data. However, it should be appreciated that the particular approach, as well as the weight that each status condition takes in determining the preferred segment size can vary without departing from the spirit and scope of the present invention.

Once the preferred segment size is determined, the status condition monitor 830 can provide the preferred segment size to the source of the wireless data segments, wherein the wireless data source can then transmit data segments using the preferred segment size. However, in various embodiments, as discussed above, the status condition monitor 830 can alternatively provide the various status conditions to the wireless data source, wherein the wireless data source can similarly derive a preferred segment size and transmit data using the preferred segment size.

As more segments of data are received by the interface device 770, the status condition monitor 830 can continually monitor and accumulate the status conditions and appropriately modify the preferred segment size as the status conditions change over time.

Returning to FIG. 8, it should be appreciated that, in a second series of operations, the interface device 770 can also receive data from a local device such as a PDA, package the received data into one or more segments, and provide the segments to a remote wireless device, such as an access point, using the wireless input/output interface 870. In the second series of operations, and under control of the controller 810, data can received using the local input/output interface 890 and provided to the segment forming device 840.

In various embodiments, as data is received and packaged by the segment forming device 840, the segment forming device 840 can receive a preferred segment size relating to a wireless channel and package the data using preferred-sized segments. In other embodiments, the segment forming device 840 can receive status conditions relating to the wireless channel, derive the preferred segment size and package the data using preferred-sized segments before exporting the preferred-sized data segments.

As data is continuously received and packaged, it should be appreciated that the preferred segment size can vary with as status conditions vary. Accordingly, the preferred segment size can be periodically updated as data is packaged into segments and exported.

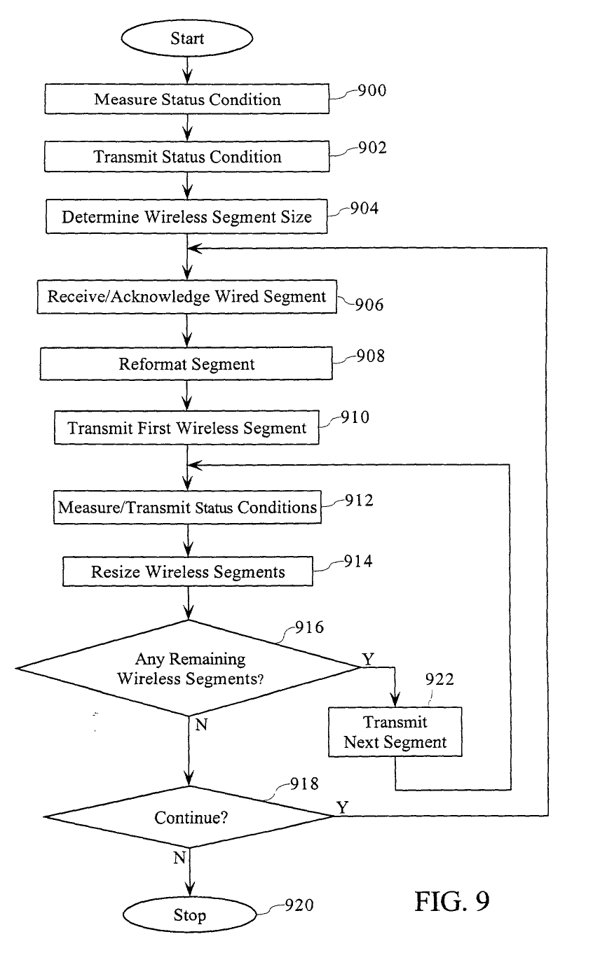

FIG. 9 depicts a flowchart outlining an exemplary process for adaptively transmitting information from a controller to a wireless device, such as a cellular or satellite-based communication system. The process starts at step 900 where a number of status conditions are measured. As discussed above, the status conditions can take various forms and can include BERs, SNRs, SINRs, framing errors and the like without departing from the spirit and scope of the present invention. Furthermore, as discussed above, the status conditions can be measured or otherwise determined by various remote wireless devices and/or a local access point as well as any other device capable of measuring/determining status information associated with various wireless links without departing from the spirit and scope of the present invention. Next, in step 902, the various status information can be transmitted to a controller. The process continues to step 904.

In step 904, a desired wireless segment size can be determined based on the various status condition information. Next, in step 906, a segment of data can be received and appropriately acknowledged from a wired network such as the Internet. Then, in step 908, the data in the received segment can be reformatted, i.e., repackaged into one or more segments of the size determined in step 904. The process continues to step 910.

In step 910, the first segment packaged in step 908 is transmitted to the intended wireless destination. Next, in step 912, further status conditions can be measured/determined and transmitted to a controller. For example, as the first segment is transmitted on an outgoing link, the intended receiver can measure various status conditions associated with the outgoing link and transmit the status condition information using a complementary incoming link. The process continues to step 914.

In step 914, the preferred size of the wireless segments can again be determined or otherwise adjusted. For example, if the status condition information determined in step 914 indicate that the wireless link carrying the segment of step 910 is becoming more prone to errors, then the desired size of the wireless segments can be reduced. Next, in step 916, a determination is made as to whether any further segments generated in step 908 remain. If there are no remaining segments, then control continues to step 918; otherwise, control jumps to step 922.

In step 922, the next segment generated in step 908 is transmitted and control jumps back to step 912, where further status conditions can be measured/determined and transmitted to a controller. Steps 912-916 and 922 can then be repeated until none of the segments generated in step 908 remain.

In step 918, a determination is made whether to continue to transfer data. If no further data is to be transferred, then control continues to step 920 where the process stops; otherwise, control jumps back to step 906 where further segments can be received from the wired network. Steps 906-922 can then be repeated until a determination is made to discontinue the process.

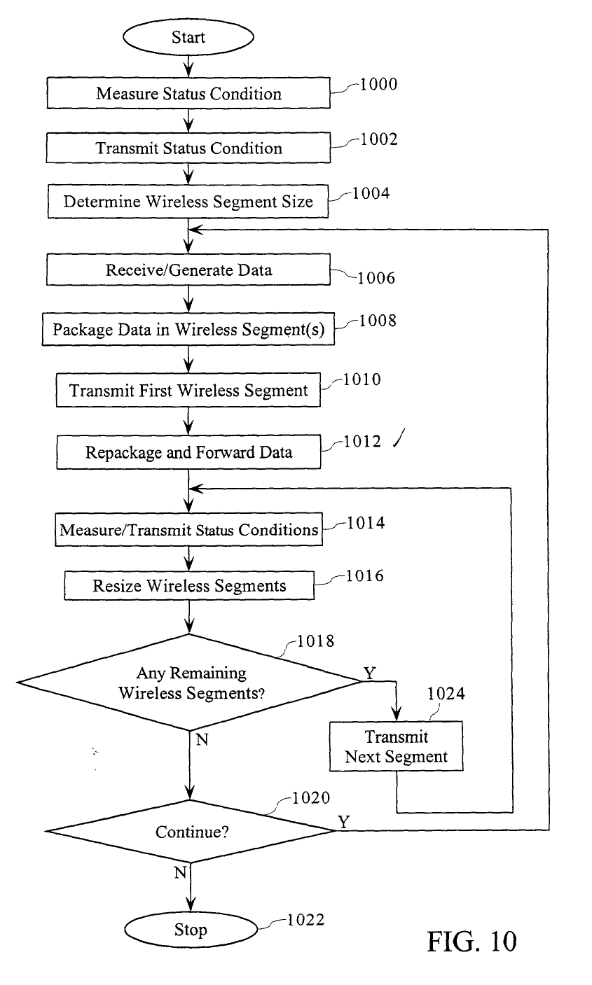

FIG. 10 depicts a flowchart outlining a second exemplary process for adaptively transmitting information between two devices using a wireless link, such as a cellular or satellite-based communication system. The process starts at step 1000 where a number of status conditions are measured. As discussed above, the status conditions can take various forms and can include BERs, SNRs, SINRs, framing errors and the like without departing from the spirit and scope of the present invention. Furthermore, as discussed above, the status conditions can be measured or otherwise determined by various remote wireless devices as well as measured locally. Next, in step 1002, those status conditions remotely measured can be transmitted by the remote device and received locally by a wireless device. The process continues to step 1004.

In step 1004, a desired wireless segment size can be determined based on the various status condition information. As discussed above, the desired wireless segment size can be determined locally, or the desired wireless segment size can be determined remotely and transmitted in lieu of the status condition information transmitted in step 1002. The process continues to step 1006.

In step 1006, data can be received/generated by a local data source, such as a PDA. Then, in step 1008, the received data can be packaged into one or more segments of the size determined in step 1004. Then, in step 1010, the first segment packaged in step 1008 can be transmitted to the intended wireless destination, such as an access point. The process continues to step 1012.

In step 1012, segment transmitted in step 1010 can be received and forwarded. If the receiving device is a wired/wireless interface, the wired/wireless interface can optionally repackage the data in the received segments into a form more appropriate for a wired network. If the receiving device is another wireless device, such as a cellular phone, the wireless device can extract the data contained in the received segments and forward the extracted data to a data sink. The process continues to step 1014.

In step 1014, further status conditions can be measured/determined and transmitted to the wireless device. For example, as the first segment is transmitted on an outgoing link, the intended receiver can measure various status conditions, such as a BER associated with the outgoing link and transmit the status condition information using a complementary incoming link. The process continues to step 1016.

In step 1016, the preferred size of the wireless segments can again be determined or otherwise adjusted. Next, in step 1018, a determination is made as to whether any further segments generated in step 1008 remain. If there are no remaining segments, then control continues to step 1020; otherwise, control jumps to step 1024.

In step 1024, the next segment generated in step 1008 is transmitted and control jumps back to step 1014, where further status conditions can be measured/determined and transmitted. Steps 1014-1018 and 1024 can then be repeated until none of the segments generated in step 1008 remain.

In step 1020, a determination is made whether to continue to transfer data. If no further data is to be transferred, then control continues to step 1022 where the process stops; otherwise, control jumps back to step 1006 where further segments can be received. Steps 1006-1024 can then be repeated until a determination is made to discontinue the process.

As shown in FIGS. 9-10, the methods of this invention are preferably implemented using a general purpose computer such as a personal computer with peripheral integrated circuit elements and dedicated communication hardware. However, the interface device 770 can be implemented using any combination of one or more programmed special purpose computers, programmed microprocessors or micro-controllers and peripheral integrated circuit elements, ASIC or other integrated circuits, digital signal processors, hardwired electronic or logic circuits such as discrete element circuits, programmable logic devices such as a PLD, PLA, FPGA or PAL, or the like. In general, any device capable of implementing a finite state machine that is in turn capable of implementing the flowchart shown in FIGS. 9-10 can be used to implement the interface device 770.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. Thus, there are changes that may be made without departing from the spirit and scope of the present invention.

What is claimed is:

1. A method for communicating, comprising:
receiving a first signal over a wireless link;
determining one or more first status conditions associated with the wireless link based on the first signal; and
receiving one or more first segments from a first channel of the wireless link having a format, wherein the format is determined based on the one or more first status conditions.

2. The method of claim 1, wherein the format includes a first segment size.

3. The method of claim 2, further comprising transmitting first status information over the wireless link.

4. The method of claim 3, wherein the first status information includes at least one first status condition.

5. The method of claim 3, further comprising determining the first segment size.

6. The method of claim 3, wherein the first status information includes at least an indication of the first segment size.

7. The method of claim 3, wherein the wireless link is based on a continuous communication technique.

8. The method of claim 3, further comprising:
receiving first data from a wired network; and
packaging the first data into the one or more first segments.

9. The method of claim 3, further comprising:
receiving first data from a wireless device; and
packaging the first data into the one or more first segments.

10. The method of claim 9, wherein the wireless device is a mobile wireless device.

11. The method of claim 3, further comprising sending a first acknowledgment for at least one first segment over the wireless link.

12. The method of claim 11, wherein the one or more first segments are based on transmission control protocol (TCP).

13. The method of claim 3, further comprising:
determining one or more second status conditions associated with the wireless link; and
receiving one or more second segments from the first channel of the wireless link having a second segment size, wherein the second segment size is determined based the one or more second status conditions.

14. The method of claim 13, wherein at least one of the first status condition is based on at least an error rate associated with the first channel.

15. The method of claim 13, wherein at least one of the first status condition is based on at least a signal level associated with the first channel.

16. The method of claim 15, wherein the one first status condition is further based on at least one of a noise level associated with the first channel and an interference level associated with the first channel.

17. The method of claim 14, wherein the one first status condition is further based on at least a rate of change of an error parameter.

18. The method of claim 13, wherein the wireless link is a cellular link.

19. The method of claim 13, wherein the wireless link is a satellite-based link.

20. The method of claim 13, wherein the first segment size is determined based on at least one first status condition associated with the first channel, and wherein the second segment size is determined based on at least one second status condition associated with the first channel.

21. The method of claim 9, further comprising:
extracting the first data from the one or more first segments; and
transmitting one or more wired segments over a wired network, wherein the one or more wired segments contain the first data extracted from the one or more first segments, and wherein the size of at least one the wired segments is different that the size of at least one of the first segments.

22. The method of claim 3, wherein the one or more first segments contain data received from a wired network.

23. The method of claim 3, wherein the one or more first segments are provided to a wired network.

24. A wireless device, comprising:
a first interface that receives first data;
a segment forming device that packages the first data into one or more first segments, wherein the size of the first segments is based on one or more first status conditions; and
a wireless interface that transmits the one or more first status conditions to a remote device using a wireless link.

25. The device of claim 24, further comprising a status device that determines the size of the first segments.

26. The device of claim 25, wherein the one or more first status conditions are received from the remote device over the wireless link

27. The device of claim 24, wherein the size of the first segments is determined by the remote device.

28. The device of claim 24, wherein the wireless link is based on a continuous communication technique.

29. The device of claim 24, wherein the wireless device is a mobile wireless device.

30. The device of claim 24, wherein the first interface is coupled to a wired network and the first data is received from the wired network.

31. The device of claim 24, wherein the wireless interface receives one or more wireless segments.

32. The method of claim 25, further comprising an acknowledgment device that generates an acknowledgment signal in response to a received wireless segment.

33. The method of claim 32, wherein the received wireless segments are based on transmission control protocol (TCP).

34. The method of claim 24, wherein at least one of the first status condition is based on at least an error rate associated with the wireless link.

35. The method of claim 24, wherein at least one of the first status condition is based on at least a signal level associated with the wireless link.

36. The method of claim 35, wherein the one first status condition is further based on at least one of a noise level associated with the wireless link and an interference level associated with the wireless link.

37. The method of claim 35, wherein the one first status condition is further based on at least a rate of change of an error parameter.

38. The method of claim 34, wherein the wireless link is a cellular link.

39. The method of claim 34, wherein the wireless link is a satellite-based link.
